(19) United States
(12) Patent Application Publication
(10) Pub. No.: US 2007/0300003 A1
(43) Pub. Date: Dec. 27, 2007

(54) Method and apparatus for increasing the performance of a portable information handling system

(75) Inventors: Lawrence Edward Knepper, Lago Vista, TX (US); Randall E. Juenger, Belton, TX (US); Reynold Li Liao, Austin, TX (US); Roberto Prosperi, Cedar Park, TX (US); James Roe Utz, Round Rock, TX (US)

Correspondence Address: HAYNES AND BOONE, LLP, 901 Main Street, Suite 3100, Dallas, TX, 75202, US

(73) Assignee: Dell Products L.P., Round Rock, TX (US)

(21) Appl. No.: 11/471,944

(22) Filed: Jun. 21, 2006

(51) Int. Cl. G06F 13/00

(52) U.S. Cl. 710/303

(57) ABSTRACT

A portable information handling system (IHS) performance increasing apparatus includes a portable slice chassis that is operable to be coupled to an IHS external to a portable IHS chassis. At least one graphics processing unit is located in the portable slice chassis. The apparatus may be coupled to a portable IHS to provide increased graphics processing power for the portable IHS.

### BACKGROUND

The present disclosure relates generally to information handling systems, and more particularly to increasing the performance of a portable information handling system.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Some portable IHSs require increased performance for activities such as performance gaming, acting as a workstation, and/or a variety of other activities known in the art. These increased performance portable IHSs raise a number of issues related to them carrying a significant burden in power, battery drain, cooling issues, and weight. Furthermore, the performance features are often not required, for example, when the increased performance portable IHS is used for low performance applications such as, for example, word processing or electronic mail.

The conventional solution to some of these issues is to provide a docking station or port replicator to allow for some of the burden, primarily the display, keyboard, and hard drives, to be removed from the portable size and weight of the increased performance portable IHS. However, these solutions are not portable and leave behind the docking station or port replicator supplied features when the increased performance portable IHS is transported. Furthermore, the solutions typically do not provide for increased processing performance in the increased performance portable IHS.

Accordingly, it would be desirable to provide for increasing the performance of a portable IHS absent the disadvantages found in the prior methods discussed above.

### SUMMARY

According to one embodiment, a portable IHS performance increasing apparatus includes a portable slice chassis that is operable to be coupled to an IHS external to a portable IHS chassis, and a graphics processing unit located in the portable slice chassis.

### BRIEF DESCRIPTION OF THE DRAWINGS

FIG. 1 is a schematic view illustrating an embodiment of an IHS.

FIG. 2a is a top perspective view illustrating an embodiment of a portable IHS performance increasing apparatus.

FIG. 2b is a bottom perspective view illustrating an embodiment of the portable IHS performance increasing apparatus of FIG. 2a.

FIG. 2c is a schematic view illustrating an embodiment of the portable IHS performance increasing apparatus of FIGS. 2a and 2b.

FIG. 2d is a schematic view illustrating an embodiment of the portable IHS performance increasing apparatus of FIGS. 2a, 2b and 2c.

FIG. 3 is a bottom perspective view illustrating an embodiment of a portable IHS chassis used with the portable IHS performance increasing apparatus of FIGS. 2a, 2b, 2c and 2d.

FIG. 4a is a bottom perspective view illustrating an embodiment of the portable IHS performance increasing apparatus of FIGS. 2a, 2b, 2c and 2d coupled to the portable IHS chassis of FIG. 3.

FIG. 4b is a side view illustrating an embodiment of the portable IHS performance increasing apparatus and the portable IHS chassis of FIG. 4a.

FIG. 5a is a perspective view illustrating an alternative embodiment of a portable IHS performance increasing apparatus used with the portable IHS of FIG. 3.

FIG. 5b is a perspective view illustrating an embodiment of the portable IHS performance increasing apparatus of FIG. 5a coupled to the portable IHS of FIG. 3.

### DETAILED DESCRIPTION

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a network server or storage device, a switch router or other network communication device, or any other suitable device and may vary in size, shape, performance, functionality, and price. The IHS may include memory, one or more processing resources such as a central processing unit (CPU) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

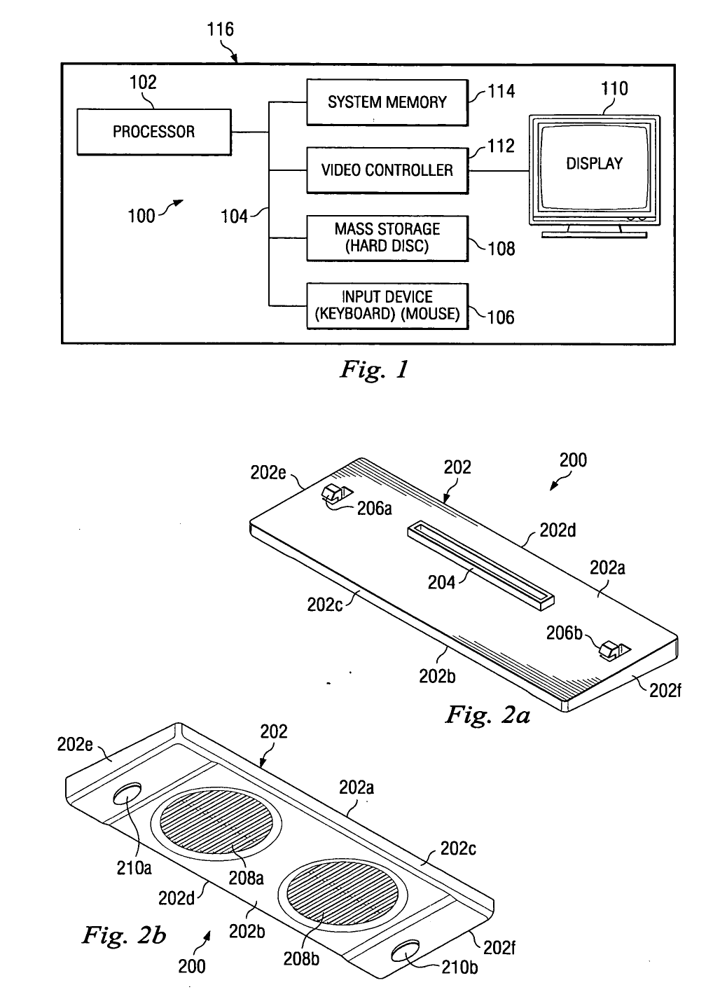

In one embodiment, IHS 100, FIG. 1, includes a microprocessor 102, which is connected to a bus 104. Bus 104 serves as a connection between microprocessor 102 and other components of computer system 100. An input device 106 is coupled to microprocessor 102 to provide input to microprocessor 102. Examples of input devices include keyboards, touchscreens, and pointing devices such as mouses, trackballs and trackpads. Programs and data are stored on a mass storage device 108, which is coupled to microprocessor 102. Mass storage devices include such devices as hard disks, optical disks, magneto-optical drives, floppy drives and the like. IHS system 100 further includes a display 110, which is coupled to microprocessor 102 by a video controller 112. A system memory 114 is coupled to microprocessor 102 to provide the microprocessor with fast storage to facilitate execution of computer programs by microprocessor 102. In an embodiment, a chassis 116 houses some or all of the components of IHS 100. It should be understood that other buses and intermediate circuits can be deployed between the components described above and microprocessor 102 to facilitate interconnection between the components and the microprocessor.

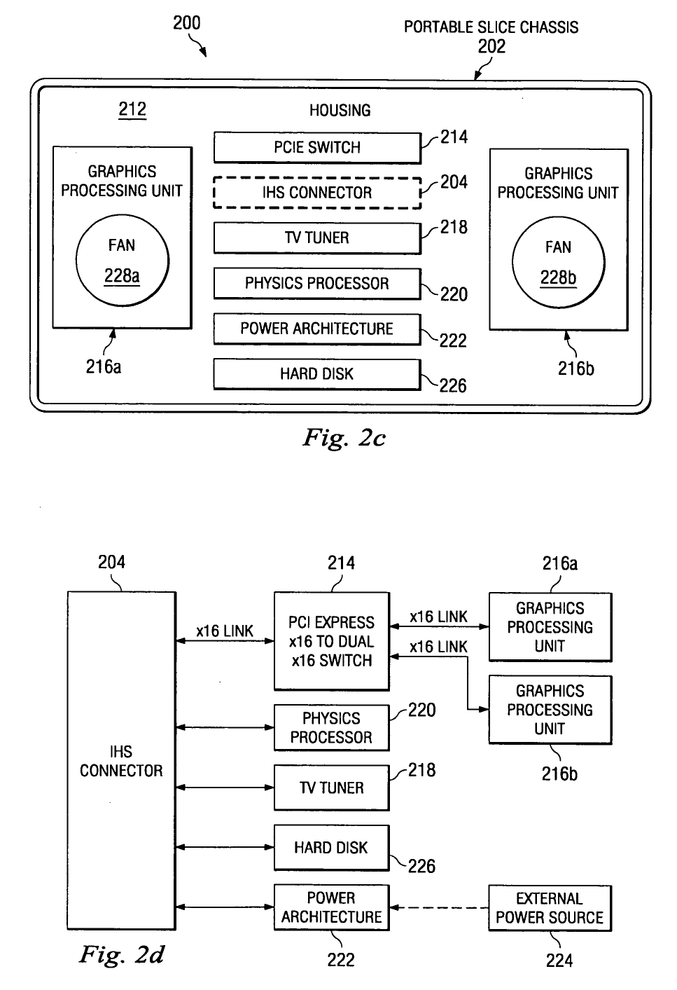

Referring now to FIGS. 2a, 2b, 2c, and 2d, a portable IHS performance increasing apparatus 200 is illustrated. The portable IHS performance increasing apparatus 200 includes a portable slice chassis 202 having a top surface 202a, a bottom surface 202b located opposite the top surface 202a, a front surface 202c extending between the top surface 202a and the bottom surface 202b, a rear surface 202d located opposite the front surface 202c and extending between the top surface 202a and the bottom surface 202b, and a pair of opposing side surfaces 202e and 202f extending between the top surface 202a, the bottom surface 202b, the front surface 202c and the rear surface 202d. An IHS connector 204 extends from the top surface 202a of the portable slice chassis 202 and is located substantially midway between the side surfaces 202e and 202f and adjacent the rear surface 202d. In an embodiment, the IHS connector 204 may include, for example, a 20 lane PCIE connection that provides a 16 lane graphics link and a 4 lane link or, alternatively, four 1 lane links. An IHS chassis coupler 206a is moveably coupled to the portable slice chassis 202, extends from the top surface 202a of the portable slice chassis 202, and is located adjacent the side surface 202e. An IHS chassis coupler 206b is moveably coupled to the portable slice chassis 202, extends from the top surface 202a of the portable slice chassis 202, and is located opposite the IHS connector 204 from the IHS chassis coupler 206a and adjacent the side surface 202f. A pair of vent features 208a and 208b are defined by the portable slice chassis 202 and located on the bottom surface 202b of the portable slice chassis 202 adjacent the side surfaces 202e and 202f, respectively. A pair of supports 210a and 210b extend from the bottom surface 202b of the portable slice chassis 202, with the support 210a located between the vent feature 208a and the side surface 202e and the support 210b located between the vent feature 208b and the side surface 202f.

The portable slice chassis 202 also defines a housing 212 that is located between the top surface 202a, the bottom surface 202b, the front surface 202c, the rear surface 202d, and the side surfaces 202e and 202f. A Peripheral Component Interconnect Express (PCIE) switch 214 is located in the housing 212 and is coupled to and operable to send signals to and receive signals from the IHS connector 204. In an embodiment, the PCIE switch 214 is a x16 to dual x16 switch that is coupled to the IHS connector by a x16 link. A pair of graphics processing units 216a and 216b are located in the housing 212 and coupled to and operable to send signals to and receive signals from the PCIE switch 214. In an embodiment, the graphics processing units 216a and 216b may include, for example, a processor, a memory, regulators, and/or a variety of other graphics processing components known in the art. In an embodiment, the graphics processing units 216a and 216b may be replaced by processors operable to accomplish tasks other than graphics processing. In an embodiment, the graphics processing units 216a and 216b are each coupled to the PCIE switch 214 by a x16 link. A television (TV) tuner 218 is located in the housing 212 and coupled to and operable to send signals to and receive signals from the IHS connector 204. In an embodiment, the physics processor 220 is a gaming signal processor known in the art operable to process gaming physics. A physics processor 220 is located in the housing 212 and coupled to and operable to send signals to and receive signals from the IHS connector 204. A power architecture 222 is located in the housing 212 and coupled to and operable to send power to and receive power from the IHS connector 204. In an embodiment, the power architecture 222 may include, for example, a battery, a battery charger, a voltage regulator, and or a variety of other power architecture components known in the art. In an embodiment, the power architecture 222 may be coupled to and operable to receive power from an external power source 224. A hard disk 226 is located in the housing 212 and coupled to and operable to send signals to and receive signals from the IHS connector 204. A pair of fans 228a and 228b are located in the housing 212 adjacent the graphics processing units 216a and 216b, respectively, and the vent features 208a and 208b, respectively.

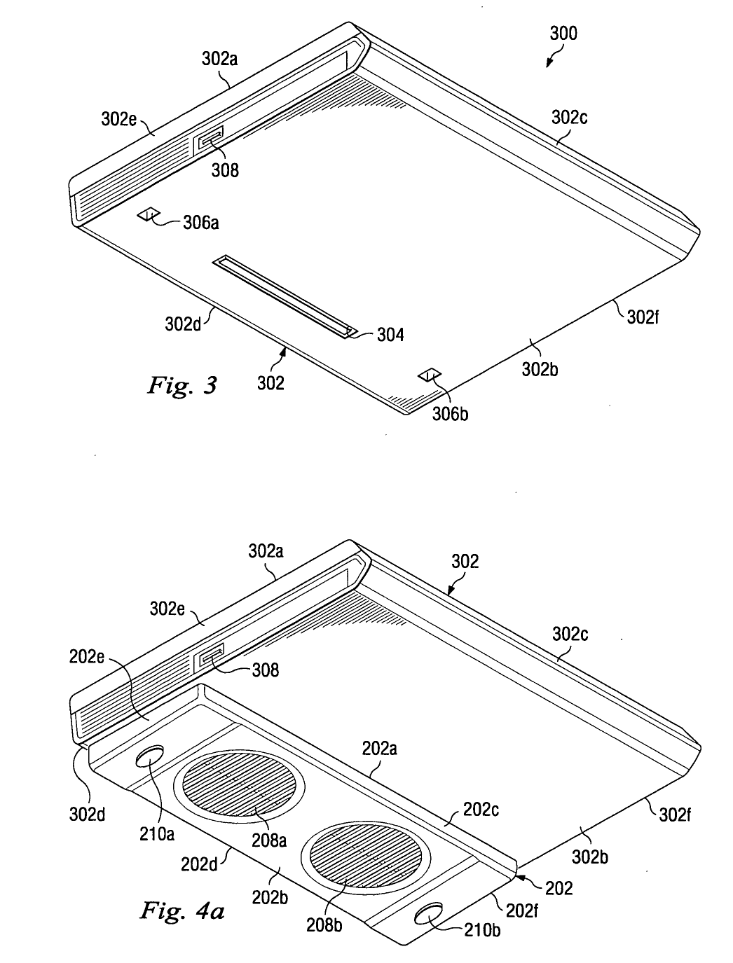

Referring now to FIG. 3, a portable IHS chassis 300 is illustrated. The chassis 300 may be, for example, the chassis 116, described above with reference to FIG. 1, and may house some or all of the components of the IHS 100, described above with reference to FIG. 1. The portable IHS chassis 300 includes a base 302 having a top surface 302a, a bottom surface 302b located opposite the top surface 302a, a front surface 302c extending between the top surface 302a and the bottom surface 302b, a rear surface 302d located opposite the front surface 302c and extending between the top surface 302a and the bottom surface 302b, and a pair of opposing side surfaces 302e and 302f extending between the top surface 302a, the bottom surface 302b, the front surface 302c, and the rear surface 302d. A slice connector 304 is defined by the base 302 and located on the bottom surface 302b of the base 302 adjacent the rear surface 302d. An apparatus securing member 306a is defined by the base 302 and located on the base 302 adjacent the rear surface 302d and the side surface 302e. An apparatus securing member 306b is defined by the base 302 and located on the base 302 opposite the slice connector 304 from the apparatus securing member 306a and adjacent the rear surface 302d and the side surface 302f. A slice connector 308 is defined by the base 302 and substantially centrally located on the side surface 302e of the base 302. In an embodiment, the slice connector 304 and/or the slice connector 308 may be electrically coupled to a processor (not shown) such as, for example, the processor 102, described above with reference to FIG. 1.

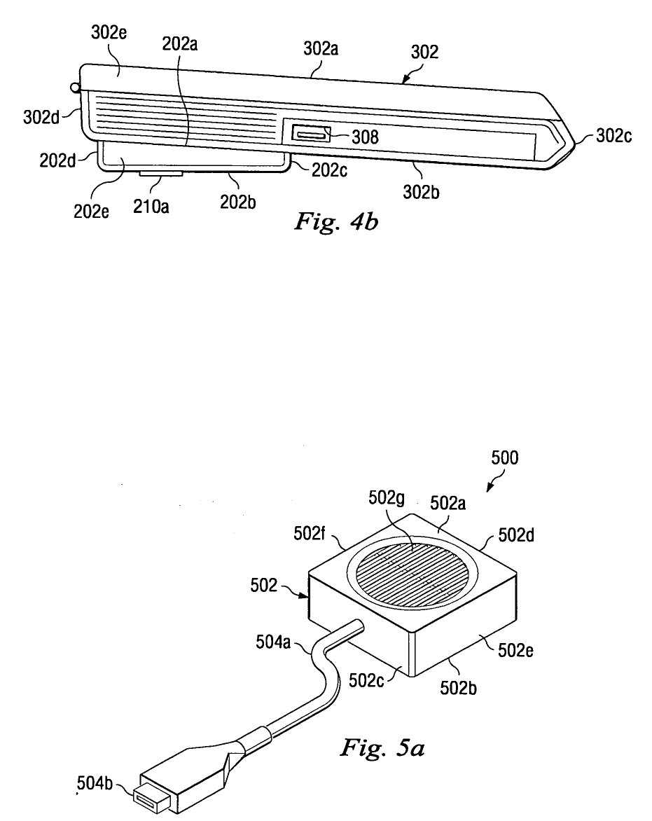

Referring now to FIGS. 4a and 4b, in operation, the portable IHS performance increasing apparatus 200 is coupled to the portable IHS chassis 300 by positioning the portable IHS performance increasing apparatus 200 adjacent the portable IHS chassis 300 such that the top surface 202a of the portable IHS performance increasing apparatus 200 is adjacent the bottom surface 302b of the portable IHS chassis 300 with the IHS connector 204 located adjacent the slice connector 304 and the IHS chassis couplers 206a and 206b located adjacent the apparatus securing members 306a and 306b, respectively. The portable IHS performance increasing apparatus 200 is then moved towards the portable IHS chassis 300 such that the IHS connector 204 engages the slice connector 304 and the IHS chassis couplers 206a and 206b engage the apparatus securing members 306a and 306b, electrically coupling and securing the portable IHS performance increasing apparatus 200 to the portable IHS chassis 300, as illustrated in FIGS. 4a and 4b. With the portable IHS performance increasing apparatus 200 electrically coupled to the portable IHS chassis 300, the portable IHS chassis 300 may utilize the graphics processing units 216a and 216b, the TV tuner 218, the physics processor 220, the power architecture 222, and the hard disk 226, in order to increase the performance of the portable IHS chassis 300 relative to the performance of the portable IHS chassis 300 without the portable IHS performance increasing apparatus 200 electrically coupled to it. In an embodiment, the size of the portable IHS performance increasing apparatus 200 may be increased to include additional components to increase the performance of the portable IHS chassis 300 and the portable IHS performance increasing apparatus 200 such that the portable IHS performance increasing apparatus 200 extends across the entire bottom surface 302b of the portable IHS chassis 300. In an embodiment, the portable IHS performance increasing apparatus 200 may couple to surfaces other than the bottom surface 302b of the portable IHS chassis 300 such as, for example, the top surface 302a, the rear surface 302d, or the sides surface 302e or 302f. Thus, a method and apparatus are provided for increasing the performance of a portable IHS, the apparatus being portable itself, such that the portable IHS may function as a smaller and lower weight portable IHS when performance of the portable IHS is not an issue, and may function has a high performance portable IHS when performance of the portable IHS is an issue. Furthermore, the method and apparatus allow the easy upgrading of graphics processing units on a portable IHS when such a need arises.

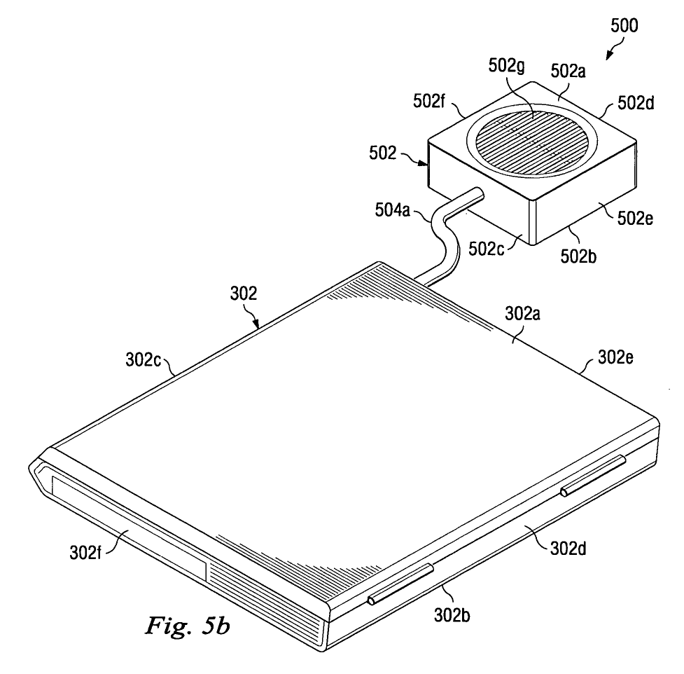

Referring now to FIGS. 2c, 2d, and 5a, in an alternative embodiment, a portable IHS performance increasing apparatus 500 is substantially similar in design and operation to the portable IHS 200, described above with reference to FIGS. 2a, 2b, 2c and 2d, with the provision of a portable slice chassis 502 replacing the portable slice chassis 202 and a cable 504a including a IHS connector 504b replacing the IHS connector 204. The portable slice chassis 502 includes a top surface 502a, a bottom surface 502b located opposite the top surface 502a, a front surface 502c extending between the top surface 502a and the bottom surface 502b, a rear surface 502d located opposite the front surface 502c and extending between the top surface 502a and the bottom surface 502b, and a pair of opposing side surfaces 502e and 502f extending between the top surface 502a, the bottom surface 502b, the front surface 502c and the rear surface 502d. A vent feature 502g is defined by the portable slice chassis 502 and substantially centrally located on the top surface 502a. The cable 504a extends from the front surface 502c and includes the IHS connector 504b on its distal end. The portable IHS performance increasing apparatus 500 defines the housing 212, illustrated in FIG. 2c, between the top surface 502a, the bottom surface 502b, the front surface 502c, the rear surface 502d, and the side surfaces 502e and 502f of the portable slice chassis 502. The components illustrated in FIG. 2c are located in the housing 212 with the provision of the IHS connector 204 being replaced by the IHS connector 504b.

Referring now to FIGS. 3, 5a, and 5b, in operation, the portable IHS performance increasing apparatus 500 is coupled to the portable IHS chassis 300 by engaging the IHS connector 504b with the slice connector 308 defined by the base 302 of the portable IHS chassis 300, electrically coupling the portable IHS performance increasing apparatus 500 to the portable IHS chassis 300, as illustrated in FIG. 5b. With the portable IHS performance increasing apparatus 500 electrically coupled to the portable IHS chassis 300, the portable IHS chassis 300 may utilize the graphics processing units 216a and 216b, the TV tuner 218, the physics processor 220, the power architecture 222, and the hard disk 226, in order to increase the performance of the portable IHS chassis 300 relative to the performance of the portable IHS chassis 300 without the portable IHS performance increasing apparatus 500 electrically coupled to it. Thus, a method and apparatus are provided for increasing the performance of a portable IHS, the apparatus being portable itself, such that the portable IHS may function as a smaller and lower weight portable IHS when performance of the portable IHS is not an issue, and may function has a high performance portable IHS when performance of the portable IHS is an issue. Furthermore, the method and apparatus allow the easy upgrading of graphics processing units on a portable IHS when such a need arises.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A portable information handling system (IHS) performance increasing apparatus, comprising:
a portable slice chassis that is operable to be coupled to an IHS external to a portable IHS chassis; and
at least one graphics processing unit located in the portable slice chassis.

2. The apparatus of claim 1, further comprising:
an IHS connector located on the portable slice chassis and operable to couple to a slice connector located on the portable IHS chassis.

3. The apparatus of claim 2, further comprising:
a plurality of IHS chassis couplers located on the portable slice chassis and operable to engage the IHS chassis to secure the portable slice chassis to the IHS chassis.

4. The apparatus of claim 1, comprising:
a cable extending from the portable slice chassis; and
an IHS connector located on the cable and operable to couple to a slice connector on the portable IHS chassis.

5. The apparatus of claim 1, further comprising:
a fan located in the portable slice chassis.

6. The apparatus of claim 1, further comprising:
a physics processor located in the portable slice chassis.

7. The apparatus of claim 1, further comprising:
a television tuner located in the portable slice chassis.

8. The apparatus of claim 1, further comprising:
a power architecture located in the portable slice chassis.

9. The apparatus of claim 1, further comprising:
a hard disk located in the portable slice chassis.

10. A portable IHS, comprising:
a portable IHS chassis;
an IHS processor located in the IHS chassis;
a slice connector located on the IHS chassis and electrically coupled to the IHS processor;
a portable slice chassis coupled to the slice connector on the portable IHS chassis and located external to the portable IHS chassis; and
at least one graphics processing unit located in the portable slice chassis.

11. The system of claim 10, further comprising:
an IHS connector located on the portable slice chassis and coupled to the slice connector on the portable IHS chassis.

12. The system of claim 11, further comprising:
a plurality of IHS chassis couplers located on the portable slice chassis and engaging the IHS chassis to secure the portable slice chassis to the IHS chassis.

13. The system of claim 10, comprising:
a cable extending from the portable slice chassis; and
an IHS connector located on the cable and coupled to the slice connector on the portable IHS chassis.

14. The system of claim 10, further comprising:
a fan located in the portable slice chassis.

15. The system of claim 10, further comprising:
a physics processor located in the portable slice chassis.

16. The system of claim 10, further comprising:
a television tuner located in the portable slice chassis.

17. The system of claim 10, further comprising:
a power architecture located in the portable slice chassis.

18. The system of claim 17, wherein the power architecture is coupled to a power source external to the portable slice chassis and the portable IHS chassis.

19. The system of claim 10, further comprising:
a hard disk located in the portable slice chassis.

20. A method for increasing the performance of a portable IHS, comprising:
providing a portable IHS; and
increasing the performance of the portable IHS by coupling a portable slice chassis to the portable IHS, the portable slice chassis comprising a graphics processing unit located in the portable slice chassis.
